(19) United States
(12) Patent Application Publication
(10) Pub. No.: US 2024/0288274 A1
(43) Pub. Date: Aug. 29, 2024

(54) CONSTRUCTION ZONE DETECTION BY AN AUTONOMOUS VEHICLE

(71) Applicant: GM Cruise Holdings LLC, San Francisco, CA (US)

(72) Inventors: Changkai Zhou, Mountain View, CA (US); Shuqin Xie, Sunnyvale, CA (US); Jianqiao Feng, Sunnyvale, CA (US); Elad Plaut, Mountainview, CA (US); Tor Aksel Notland Heirung, San Francisco, CA (US); Eric Lujan, San Francisco, CA (US); Nestor Grace, San Francisco, CA (US); Kevin Yuwen Tong, Carlsbad, CA (US); Raghid Mardini, Oakland, CA (US)

(21) Appl. No.: 18/175,241

(22) Filed: Feb. 27, 2023

(51) Int. Cl. G01C 21/34

(52) U.S. Cl. CPC G01C 21/3461

(57) ABSTRACT

Systems and techniques are provided for detecting construction zones by an autonomous vehicle. An example method includes detecting, by an autonomous vehicle, a first construction object and a second construction object; determining an association between the first construction object and the second construction object, wherein the association is based on at least one distance between the first construction object and the second construction object; identifying, based on the association, at least one temporary traffic restriction corresponding to the first construction object and the second construction object; and configuring a route of the autonomous vehicle based on the at least one temporary traffic restriction.

### BACKGROUND

### 1. Technical Field

The present disclosure generally relates to autonomous vehicles. For example, aspects of the present disclosure relate to systems and techniques for enabling autonomous vehicles to identify temporary traffic restrictions such as construction zones.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at specific locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 is a diagram illustrating an example system environment that can be used to facilitate autonomous vehicle (AV) navigation and routing operations, according to some examples of the present disclosure;

FIG. 2 is a diagram illustrating an example system for performing construction zone detection by an autonomous vehicle, according to some examples of the present disclosure;

FIG. 3 is a diagram illustrating an example configuration of a construction zone scene that can be detected by an autonomous vehicle, according to some examples of the present disclosure;

FIG. 4 is a diagram illustrating another example configuration of a construction zone scene that can be detected by an autonomous vehicle, according to some examples of the present disclosure;

FIG. 5 is a diagram illustrating another example configuration of a construction zone scene that can be detected by an autonomous vehicle, according to some examples of the present disclosure;

FIG. 6 is an example of a deep learning neural network that can be used to implement aspects of construction zone detection and identification, according to some examples of the present disclosure;

FIG. 7 is a flow chart illustrating an example process for detecting a construction zone by an autonomous vehicle, according to some examples of the present disclosure; and

FIG. 8 is a diagram illustrating an example system architecture for implementing certain aspects described herein, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

As previously explained, autonomous vehicles (AVs) can include various sensors, such as a camera sensor, a light detection and ranging (LIDAR) sensor, a radio detection and ranging (RADAR) sensor, an inertial measurement unit (IMU), and/or an acoustic sensor (e.g., sound navigation and ranging (SONAR), microphone, etc.), global navigation satellite system (GNSS) and/or global positioning system (GPS) receiver, amongst others. The AVs can use the various sensors to collect data and measurements that the AVs can use for AV operations such as perception (e.g., object detection, event detection, tracking, localization, sensor fusion, point cloud processing, image processing, etc.), planning (e.g., route planning, trajectory planning, situation analysis, behavioral and/or action planning, mission planning, etc.), control (e.g., steering, braking, throttling, lateral control, longitudinal control, model predictive control (MPC), proportional-derivative-integral, etc.), prediction (e.g., motion prediction, behavior prediction, etc.), etc. The sensors can provide the data and measurements to an internal computing system of the autonomous vehicle, which can use the data and measurements to control a mechanical system of the autonomous vehicle, such as a vehicle propulsion system, a braking system, and/or a steering system, for example.

In some cases, an autonomous vehicle may have difficulty autonomously navigating in scenarios where the autonomous vehicle needs to deviate from a predetermined route in an environment in order to accommodate certain temporary traffic conditions and/or events. For example, the lanes used by vehicles on the road and/or the flow of traffic through lanes on the road can be modified to accommodate certain conditions and/or events such as, for example and without limitation, construction zones, events (e.g., concerts, sporting events, festivals, protests, block parties, etc.), accidents, road closures, hazards, road obstacles, and/or other conditions and/or events. Autonomous vehicles may have difficulty understanding the scene with the modified lane which consequently can create various challenges for the autonomous vehicle if the autonomous vehicle needs to navigate the environment.

Typically, the temporary traffic condition may not be included and/or identified in a map of the environment used by an autonomous vehicle to navigate, such as a semantic map of the environment, and/or may not be included or identified in other data used by the autonomous vehicle to navigate, such as a traffic route, traffic information, an operational map, semantic information, and/or any other data used by the autonomous vehicle to navigate through the environment. Thus, the autonomous vehicle may not be able to detect and understand the temporary traffic lane(s) simply by reviewing an existing map of the environment and/or other data used by the autonomous vehicle to navigate. Accordingly, if the autonomous vehicle is otherwise unable to detect and understand the temporary traffic condition, the computer system of the autonomous vehicle may not determine an appropriate route for the autonomous vehicle. Consequently, the length and/or time of the trip may be increased as a result of the temporary traffic condition. Alternatively, in some cases, the autonomous vehicle may need to be manually guided through the temporary traffic condition by a passenger of the autonomous vehicle or a remote agent who is able to remotely guide the autonomous vehicle or take control of the autonomous vehicle.

Systems, apparatuses, processes (also referred to as methods), and computer-readable media (collectively referred to as “systems and techniques”) are described herein for enabling autonomous vehicles to detect and/or understand temporary traffic conditions such as construction zones. For example, the systems and techniques can be used by autonomous vehicles to identify one or more construction objects that may be associated with a temporary traffic condition. Examples of such construction objects can include traffic cones, flares, barricades, signs, barriers, barrels, etc. In some aspects, the systems and techniques can be used to determine an association (e.g., grouping) among the construction objects in the temporary traffic scene. In some cases, construction objects can be associated or grouped based on their position on location within the scene as determined from data from a semantic map. For instance, objects can be grouped based on their position relative to a crosswalk, intersection, lane boundary, curb, traffic signal, etc. In some instances, construction objects can be associated or grouped based on the distance between two or more of the construction objects. For example, association of construction objects can be based on absolute distance, lateral distance (e.g., perpendicular to lane direction), and/or longitudinal distance (e.g., along lane direction). In further examples, construction objects may be associated or grouped based on contextual association of the construction objects with other objects present in the scene such as construction vehicles, construction objects, humans controlling traffic, machinery, signage, etc. In some configurations, the association of construction objects can be performed by a machine learning model that is trained to identify construction objects in a temporary traffic scene.

In some aspects, the systems and techniques can be used by autonomous vehicles to identify a region or area that is obstructed or blocked due to the temporary traffic condition. For example, the autonomous vehicle may use the grouping of construction objects to identify a polygon or curved shape that is not navigable by the autonomous vehicle. In some cases, the obstructed region can be defined based on polylines that can be joined to form a polygon. In some examples, a planning stack of the autonomous vehicle may use the size and location information associated with the obstructed region to determine a revised route suitable for traversing and/or avoiding the temporary traffic restriction.

In some examples, the systems and techniques can be used by an autonomous vehicle to identify the type of temporary traffic restriction. Examples of temporary traffic restrictions an include lane closures, road closures, lane channelization, emergency vehicle blockages, etc. For instance, the autonomous vehicle can use the construction object association and/or the obstructed region together with data from a semantic map to determine the type of temporary traffic restriction.

In some cases, the systems and techniques described herein can improve performance of an autonomous vehicle by identifying and characterizing temporary traffic scenes such as construction zones. For example, the autonomous vehicle can use the systems and techniques described herein to properly navigate through or around temporary traffic restrictions, which can improve the efficiency of the autonomous vehicle by reducing travel time and travel distance. The experience of passengers will also be improved as the time for reaching a desired destination is improved and the cost of the trip is reduced.

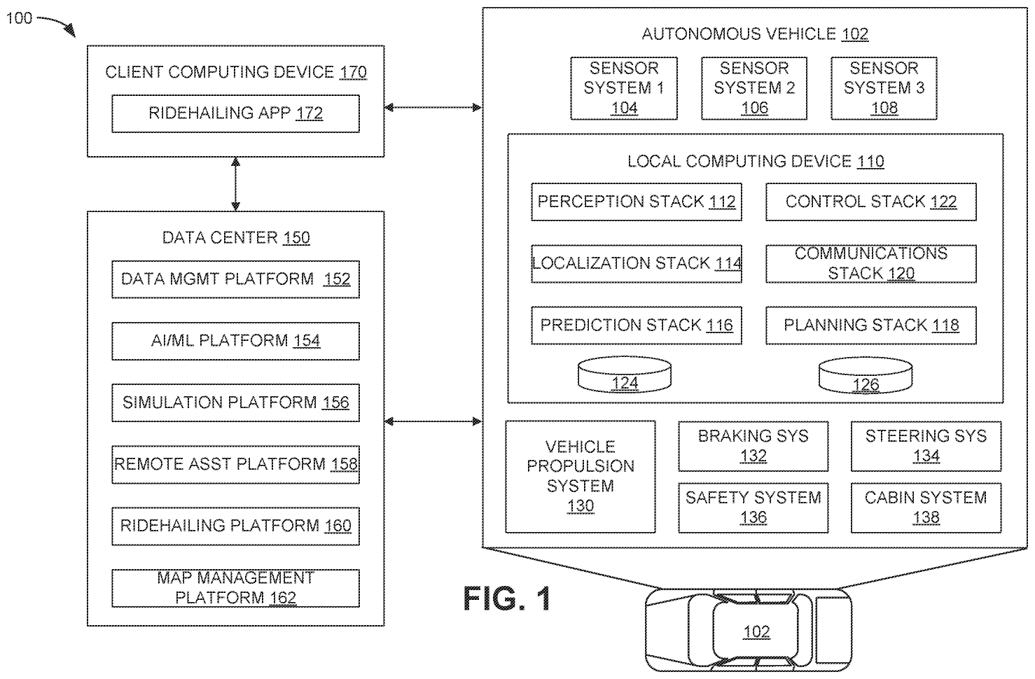

FIG. 1 is a diagram illustrating an example autonomous vehicle (AV) environment 100, according to some examples of the present disclosure. One of ordinary skill in the art will understand that, for the AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the perception stack 112 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridehailing service (e.g., a ridesharing service), a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridehailing/ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridehailing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridehailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridehailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridehailing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridehailing platform 160 can interact with a customer of a ridehailing service via a ridehailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridehailing application 172. The client computing device 170 can be a customer's mobile computing device or a computing device integrated with the AV 102 (e.g., the local computing device 110). The ridehailing platform 160 can receive requests to pick up or drop off from the ridehailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridehailing platform 160 may incorporate the map viewing services into the ridehaling application 172 to enable passengers to view the AV 102 in transit en route to a pick-up or drop-off location, and so on.

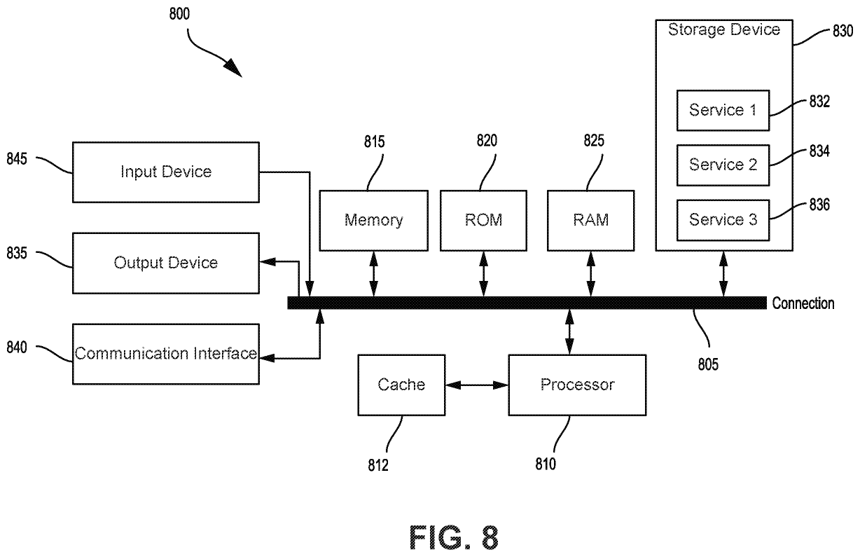

While the autonomous vehicle 102, the local computing device 110, and the autonomous vehicle environment 100 are shown to include certain systems and components, one of ordinary skill will appreciate that the autonomous vehicle 102, the local computing device 110, and/or the autonomous vehicle environment 100 can include more or fewer systems and/or components than those shown in FIG. 1. For example, the autonomous vehicle 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 8.

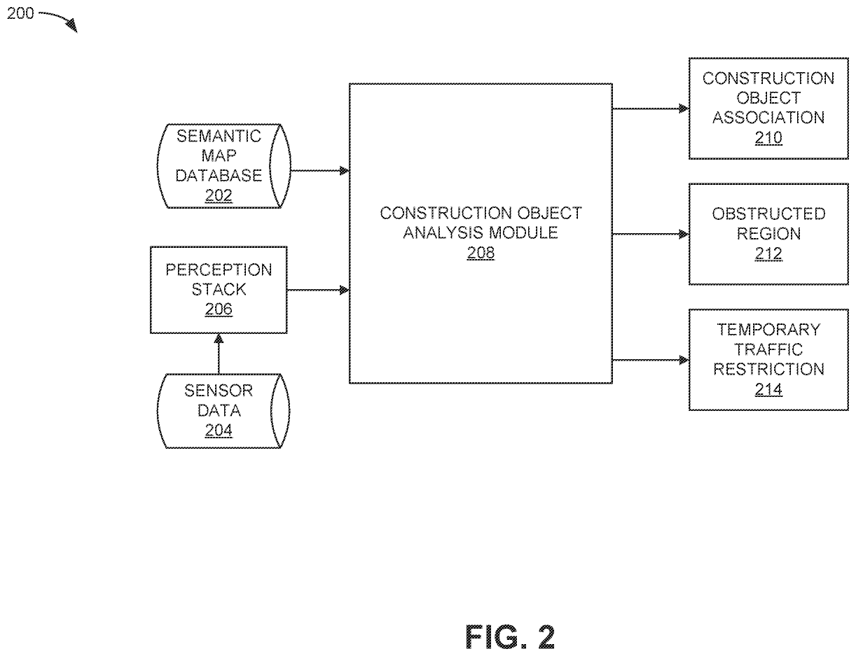

FIG. 2 illustrates an example system 200 for detecting a construction zone. In some aspects, system 200 may be part of an autonomous vehicle (AV) such as AV 102. In some examples, system 200 may include a semantic map database 202. In some cases, semantic map database 202 may be part of HD geospatial database 126. That is, semantic map database 202 may include information (e.g., labels, elements, etc.) that can be used to identify traffic lanes, traffic boundaries, intersections, medians, sidewalks, crosswalks, travel directions, speed limits, slopes, elevations, traffic signals, traffic signs, and/or any other attribute or geospatial information that may be associated with a map.

In some aspects, system 200 may include a perception stack 206. In some cases, perception stack 206 may correspond to perception stack 112. That is, perception stack 206 may use sensor data 204 (e.g., data from sensor systems 104-108) to detect and classify objects and determine their current locations, speeds, directions, etc. In some instances, perception stack 206 can use sensor data 204 to detect and classify objects that may be associated with a temporary traffic condition such as a construction zone, lane closure, road closure, emergency vehicle blockage, traffic channelization, etc. For example, perception stack 206 may detect and classify objects such as cones, posts, barriers, barrels, barricades, signs, flares, emergency vehicles, humans controlling traffic, any other object or person that may be associated with a temporary traffic condition, and/or any combination thereof.

In some examples, system 200 can include a construction object analysis module 208. In some configurations, the construction object analysis module 208 may receive input from perception stack 206 (e.g., object detection, object identification, bounding area, confidence score, etc.). In some cases, the construction object analysis module 208 may also receive or access data from semantic map database 202.

In some examples, the construction object analysis module 208 can use the data from perception stack 206 and/or semantic map database 202 to identify, detect, and/or classify temporary traffic conditions such as construction zones. For example, the construction object analysis module 208 may process data such as construction object type, absolute object location, object location relative to other objects in scene, and/or object location relative to semantic map properties to determine construction object association 210 (e.g., grouping among construction objects), obstructed region 212 (e.g., area that is obstructed by grouping of construction objects), and/or temporary traffic restriction 214 (e.g., traffic restriction associated with construction zone objects such as lane closure, road closure, emergency vehicle blockage, traffic channelization).

In some aspects, the construction object analysis module 208 may determine a construction object association 210 (e.g., grouping or correlation among two or more construction objects identified by perception stack 206). In some examples, the factors or properties used to determine the construction object association 210 between a first construction object (e.g., a first traffic cone) and a second construction object (e.g., a second traffic cone) can include: the absolute distance between the construction objects; the longitudinal distance (e.g., distance along traffic direction of lane) between the construction objects; the lateral distance (e.g., distance perpendicular to traffic direction of lane) between the construction objects; the distance between each of the construction objects and an intersection; the distance between each of the construction objects and a lane boundary; the distance between each of the construction objects and a crosswalk; the position of each of the construction objects (e.g., within an intersection, within a crosswalk, along a lane boundary); contextual association of the construction objects with other objects present in the scene such as construction vehicles, construction objects, humans controlling traffic, machinery, signage, caution tape linking objects, etc.; the orientation of the construction objects; any other factor or property associated with the construction objects; any other properties, elements, or labels obtained from the semantic map database 202; and/or any combination thereof.

For example, in some cases, the construction object association 210 can be based on a spatial relationship among one or more objects in a traffic scene and/or one or more elements in a traffic scene. That is, the spatial relationship can be determined based on the distance of a construction object relative to another construction object and/or the distance of the construction object relative to any other element in the traffic scene such as a vehicle, pedestrian, human controlling traffic, tree, traffic sign, etc. In another example, the spatial relationship can be determined based on the position of the construction object relative to another construction object and/or the position of the construction object relative to an element of a traffic scene such as a crosswalk, an intersection, a lane boundary, a sign, a traffic signal, etc. In another example, the spatial relationship can be determined based on the orientation of a construction object (e.g., absolute orientation) and/or the orientation of the construction object relative to any other objects or elements within a traffic scene.

In some instances, construction objects may be associated (e.g., grouped or linked) if a distance measurement between the constructions objects is less than or equal to a threshold value. In one illustrative example, two construction objects may be grouped if the lateral distance between the two construction objects is less than or equal to 1 meter. In another illustrative example, two construction objects may be grouped if the longitudinal distance between the two construction objects is less than or equal to 25 meters. In some aspects, the threshold distance for associating construction objects may change based on the location of the construction objects relative to the semantic map database 202. For instance, the threshold distance for associating construction objects that are located within an intersection may be different than the threshold distance for associating objects that are located along a lane boundary. In another example, the threshold distance for associating construction objects may be based on the distance of the objects relative to elements from semantic map database (e.g., distance of the construction objects from sidewalk).

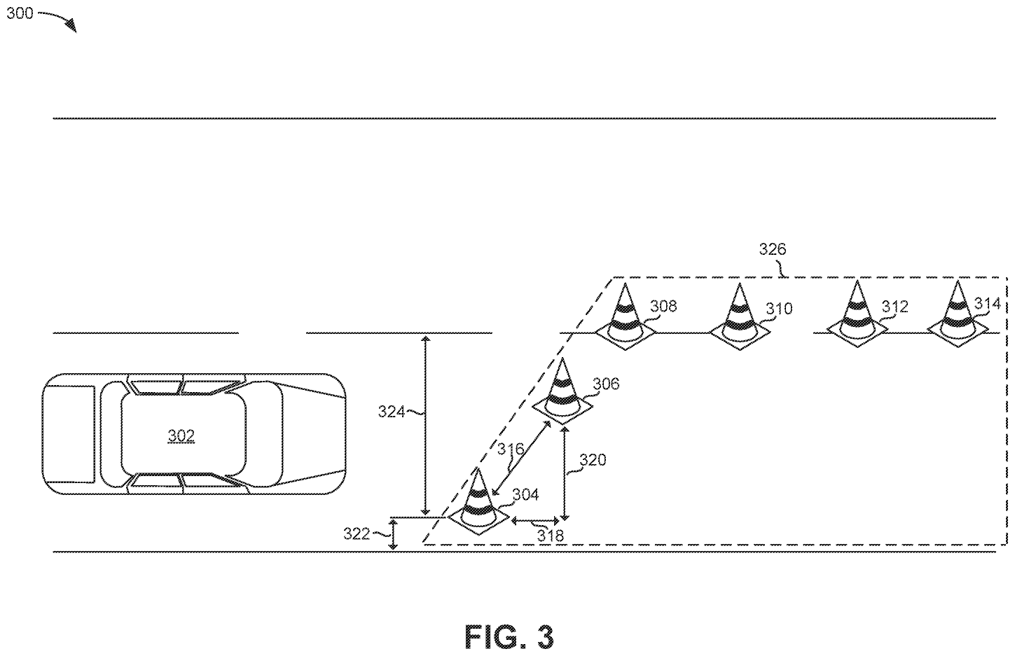

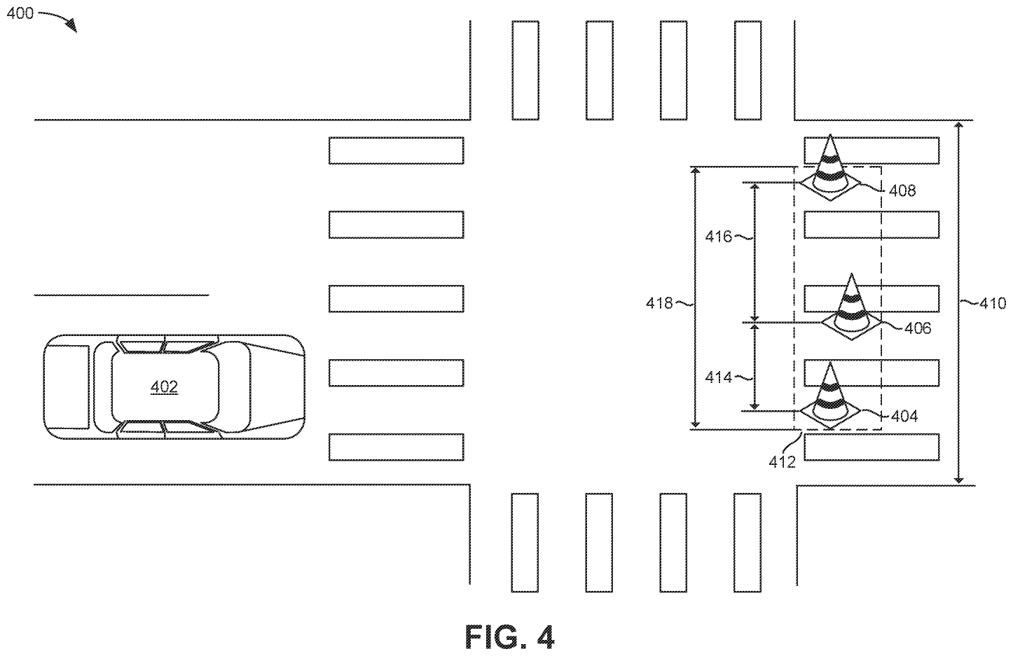

In some examples, the construction object analysis module 208 may determine an obstructed region 212 based on construction object association 210. In some cases, the obstructed region 212 may be determined by creating or defining a shape (e.g., a curved shape or a polygon) that is based on the grouping of the construction objects (e.g., see obstructed region 326 illustrated in FIG. 3 and obstructed region 412 illustrated in FIG. 4). For instance, the obstructed region 212 may be determined by creating a polygon that is based on pairwise convex hulls. In another example, the obstructed region 212 may be determined by generating polylines between pairs of construction objects and by converting the polylines into a polygon.

In some aspects, the obstructed region 212 may include multiple obstructed regions. In some instances, the obstructed region 212 may can be based on construction objects of different types (e.g., cones, barricades, barrels, etc.). In some examples, the obstructed region 212 can be provided to one or more modules or machine learning models of an AV (e.g., AV 102) that are configured to plan the route of the AV. For example, obstructed region 212 can be provided to planning stack 118 such that AV 102 plans a route that avoids obstructed region 212.

In some cases, the construction object analysis module 208 may identify a temporary traffic restriction 214 based on construction object association 210 and/or obstructed region 212. As noted above, the temporary traffic restriction 214 may include a lane closure (e.g., AV needs to merge into adjacent lane), a road closure (e.g., AV needs to reroute to avoid closed area), a traffic channelization (e.g., AV needs to follow lines of construction objects that act as temporary lane boundaries), an emergency vehicle blockage (e.g., AV needs to reroute at emergency scene).

In some configurations, construction object analysis module 208 may include multiple modules. In some cases, construction object analysis module 208 may be implemented using software algorithms that are based on the semantic relationship among construction objects. For example, construction object analysis module 208 may determine construction object association 210, obstructed region 212, and/or temporary traffic restriction 214 based on parameters, guidelines, and/or rules that are based on the properties of the construction objects and/or the properties of the semantic map database 202.

In some cases, construction object analysis module 208 may be implemented using one or more machine learning models. For example, a machine learning model may be trained to determine construction object association 210 and/or obstructed region 212 using construction zone scenes. For instance, the machine learning model may learn to perform construction object association 210 and/or identify obstructed region 212 by identifying properties from training data that may include distance measurements among construction objects (e.g., absolute distance, longitudinal distance, lateral distance), relative position of construction objects within scene (e.g., relative to other tracked objects or regions identified by semantic map database 202), object orientation, road map elements (e.g., traffic lane, crosswalk, road edge, etc.), traffic signs, sensor data (e.g., color of objects from camera data), object size, spatial relationships among objects and/or elements in a traffic scene, etc. In some examples, a machine learning model may be trained to determine temporary traffic restriction 214 based on construction object association 210, obstructed region 212, and/or training data that includes scenes having known temporary traffic restrictions (e.g., lane closures, lane blockages, traffic channelization, etc.).

FIG. 3 is a diagram illustrating an example configuration of a construction zone scene 300. In some aspects, construction zone scene 300 may include an AV 302 that may be configured to detect and identify construction zones (e.g., using system 200). In some cases, construction zone scene 300 may include a lane closure in which one lane on a multi-lane road is closed and AV 302 is required to merge into an adjacent lane.

As illustrated, the lane in which AV 302 is traveling is closed using various traffic cones (e.g., cone 304, cone 306, cone 308, cone 310, cone 312, and cone 314; collectively “cones 304-314”). In some aspects, AV 302 may determine an association among two or more of cones 304-314 based on a spatial relationship among elements in construction zone scene 300. In some cases, AV 302 may determine an association among two or more of cones 304-314 based on the distance between the cones 304-314. For example, AV 302 may determine an association between cone 304 and cone 306 based on absolute distance 316. In another example, AV 302 may determine an association between cone 304 and cone 306 based on longitudinal distance 318 (e.g., distance along traffic direction of lane). In another example, AV 302 may determine an association between cone 304 and cone 306 based on lateral distance 320 (e.g., distance perpendicular to traffic direction of lane).

In some cases, AV 302 may determine an association between cones 304-314 based on their position relative to elements identified using a semantic map. For example, AV 302 may determine the curb distance 322 corresponding to the distance between cone 304 and the curb or side of the roadway. In another example, AV 302 may determine the lane boundary distance 324 corresponding to the distance between cone 304 and the boundary between the two lanes in construction zone scene 300. In another example, AV 302 may determine an association between one or more of cones 304-314 based on their spatial relationship relative to any other object within construction zone scene 300. For instance, AV 302 may determine an association between one or more of cones 304-314 based on their spatial relationship relative to a human controlling traffic (not illustrated) or heavy machinery (not illustrated).

In some aspects, AV 302 may identify an obstructed region 326 that is based on the association between two or more of cones 304-314. For example, AV 302 may group cone 304 with cone 306; cone 306 with cone 308; cone 308 with cone 310; cone 310 with cone 312; and/or cone 312 with cone 314. In some examples, the association or grouping of cones 304-314 can be used to generate a shape (e.g., curved shape or polynomial) that corresponds to obstructed region 326. In some cases, AV 302 may use the shape, size, and/or location data associated with obstructed region 326 to identify a temporary traffic restriction. For example, the angle edge of the polynomial corresponding to obstructed region 326 may be indicative of a gradual lane closure. In another example, the topmost edge of the polynomial corresponding to obstructed region 326 that is substantially parallel to the lane boundary may be indicative of a lane closure.

FIG. 4 is a diagram illustrating an example configuration of a construction zone scene 400. In some aspects, construction zone scene 400 may include an AV 402 that may be configured to detect and identify construction zones (e.g., using system 200). In some cases, construction zone scene 400 may include a road closure in which all available lanes are closed and AV 402 must reroute to avoid the blockage.

As illustrated, the road on which AV 402 is traveling is closed using various traffic cones (e.g., cone 404, cone 406, and cone 408; collectively “cones 404-408”). In some aspects, AV 402 may determine an association among two or more of cones 404-408 based on the distance between the cones 404-408. For example, AV 402 may determine an association between cone 404 and cone 406 based on lateral distance 414. In another example, AV 402 may determine an association between cone 406 and cone 408 based on lateral distance 416. In another example, AV 402 may determine an association between cone 404 and cone 408 based on lateral distance 418.

In some aspects, AV 402 may identify an obstructed region 412 that is based on the association between cones 404-408. In some examples, AV 402 may determine that obstructed region 412 corresponds to a road closure based on the size of the obstructed region 412 relative to the size of the roadway. For example, the width of obstructed region 412 (e.g., lateral distance 418) may be compared to the width of the roadway (e.g., roadway width 410) to determine a ratio or a percentage of the roadway that is blocked. In some cases, if the blockage of the roadway (e.g., ratio of lateral distance 418 and roadway width 410) is greater than a threshold value, AV 402 may determine that obstructed region 412 corresponds to a road closure.

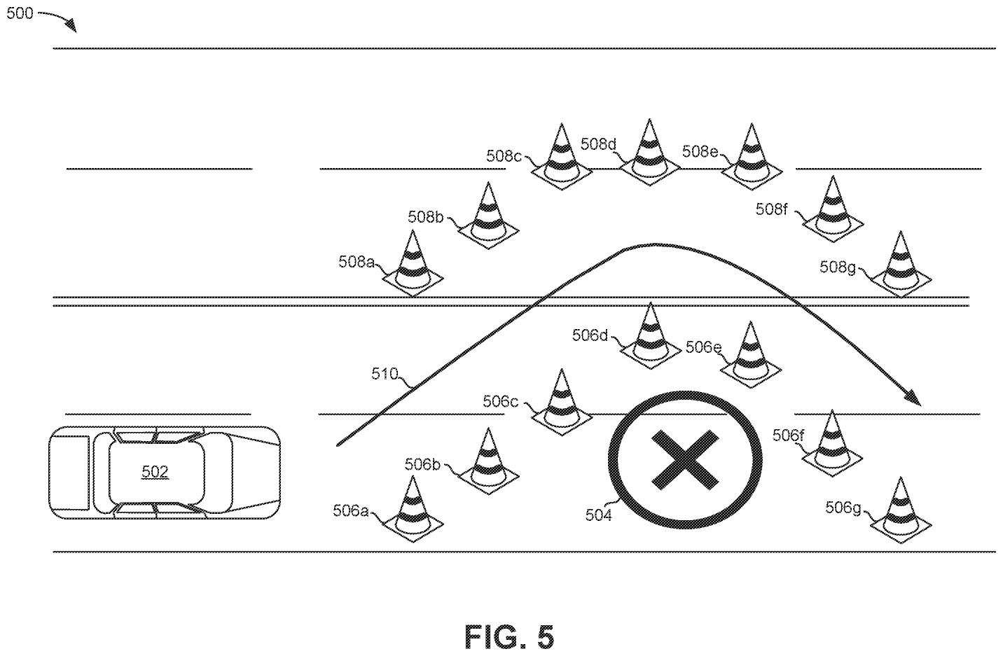

FIG. 5 is a diagram illustrating an example configuration of a construction zone scene 500. In some aspects, construction zone scene 500 may include an AV 502 that may be configured to detect and identify construction zones (e.g., using system 200). In some cases, construction zone scene 500 may include a lane channelization in which AV 502 must navigate using temporary lane boundaries that are defined using construction objects.

As illustrated, the road on which AV 502 is traveling includes lane channelization for circumventing incident 504. In some aspects, incident 504 may correspond to a construction zone (e.g., roadwork), a vehicle accident, road debris, or any other incident that may require temporary redirection of traffic. The road channelization in construction zone scene 500 is defined using a first temporary lane boundary that includes cone 506a, cone 506b, cone 506c, cone 506d, cone 506e, cone 506f, and cone 506g (collectively “cones 506”); and a second temporary lane boundary that includes cone 508a, cone 508b, cone 508c, cone 508d, cone 508e, cone 508f, and cone 508g (collectively “cones 508”).

In some aspects, AV 502 may determine an association among cones 506 and/or cones 508 based on one or more distance measurements (e.g., absolute distance, lateral distance, and/or longitudinal distance). For example, AV 502 may determine an association among cones 506 and/or cones 508 based on the longitudinal distance among a portion of cones 506 or cones 508 and/or the overall longitudinal distance of cones 506 or cones 508. In some cases, AV 502 may determine an association among cones 506 and/or cones 508 based on the position of cones 506 and/or cones 508 relative to the lane boundaries or the curb. In some instances, AV 502 may determine an association among cones 506 and/or cones 508 based on the position of cones 506 and/or cones 508 relative to incident 504. In some configurations, AV 502 may determine an association among cones 506 and/or cones 508 based on one or more other objects within construction zone scene 500. For example, incident 504 may include a truck with a cherry picker that is positioned adjacent to large trees (not illustrated), and AV 502 may use information such as the type of object and the position of the object relative to cones 506 and/or cones 508 to determine the association among cones 506 and/or cones 508.

In some cases, AV 502 may determine a revised route that is based on the temporary traffic restriction (e.g., lane channelization). For example, a planning stack (e.g., planning stack 118) of AV 502 may use the construction object association, the obstructed region, and/or the temporary traffic restriction to determine a revised route. As illustrated in FIG. 5, AV 502 may determine revised route 510 for navigating through the lane channelization as defined by cones 506 and cones 508 (e.g., for circumventing incident 504).

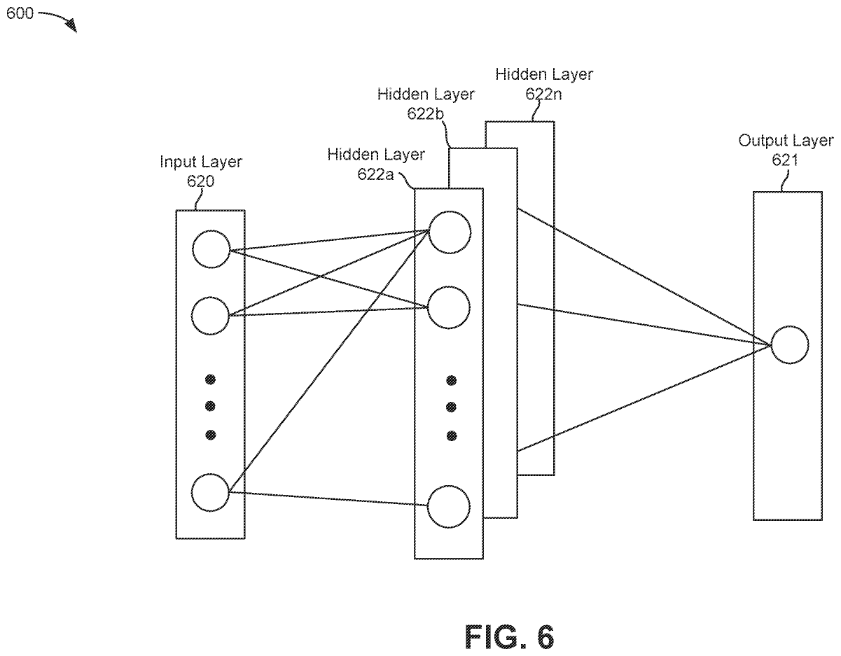

In FIG. 6, the disclosure now turns to a further discussion of models that can be used through the environments and techniques described herein. FIG. 6 is an example of a deep learning neural network 600 that can be used to implement all or a portion of the systems and techniques described herein (e.g., neural network 600 can be used to implement a construction object analysis module 208 as discussed above). In some aspects, neural network 600 can include input layer 620 (e.g., configured to receive one or more inputs); hidden layers 622a, 622b, through 622n (e.g., “n” hidden layers as needed for the given application); and output layer 621 (e.g., configured to provide output resulting from the processing performed by the hidden layers). In some cases, input layer 620 can be configured to receive the output of a perception stack (e.g., perception stack 112) such as any objects (e.g., construction objects, vehicles, pedestrians, etc.) that are identified by the perception stack. In some examples, input layer 620 can also be configured to receive data corresponding to an HD geospatial database (e.g., HD geospatial database 126) and/or a semantic map (e.g., semantic map database 202). In some aspects, output layer 621 can determine a spatial relationship among objects or elements in a traffic scene, an association or grouping of construction objects (construction object association 210), an obstructed region (e.g., region that cannot be navigated due to temporary traffic restriction), and/or a temporary traffic restriction (e.g., lane closure, road closure, lane channelization, etc.).

The neural network 600 is a multi-layer neural network of interconnected nodes. Each node can represent a piece of information. Information associated with the nodes is shared among the different layers and each layer retains information as information is processed. In some cases, the neural network 600 can include a feed-forward network, in which case there are no feedback connections where outputs of the network are fed back into itself. In some cases, the neural network 600 can include a recurrent neural network, which can have loops that allow information to be carried across nodes while reading in input.

Information can be exchanged between nodes through node-to-node interconnections between the various layers. Nodes of the input layer 620 can activate a set of nodes in the first hidden layer 622a. For example, as shown, each of the input nodes of the input layer 620 is connected to each of the nodes of the first hidden layer 622a. The nodes of the first hidden layer 622a can transform the information of each input node by applying activation functions to the input node information. The information derived from the transformation can then be passed to and can activate the nodes of the next hidden layer 622b, which can perform their own designated functions. Example functions include convolutional, up-sampling, data transformation, and/or any other suitable functions. The output of the hidden layer 622b can then activate nodes of the next hidden layer, and so on. The output of the last hidden layer 622n can activate one or more nodes of the output layer 621, at which an output is provided. In some cases, while nodes in the neural network 600 are shown as having multiple output lines, a node can have a single output and all lines shown as being output from a node represent the same output value.

In some cases, each node or interconnection between nodes can have a weight that is a set of parameters derived from the training of the neural network 600. Once the neural network 600 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 600 to be adaptive to inputs and able to learn as more and more data is processed.

The neural network 600 is pre-trained to process the features from the data in the input layer 620 using the different hidden layers 622a, 622b, through 622n in order to provide the output through the output layer 621.

In some cases, the neural network 600 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 600 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½ (target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 600 can perform a backward pass by determining which inputs (weights) most contributed to the loss of the network, and can adjust the weights so that the loss decreases and is eventually minimized.

The neural network 600 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 600 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

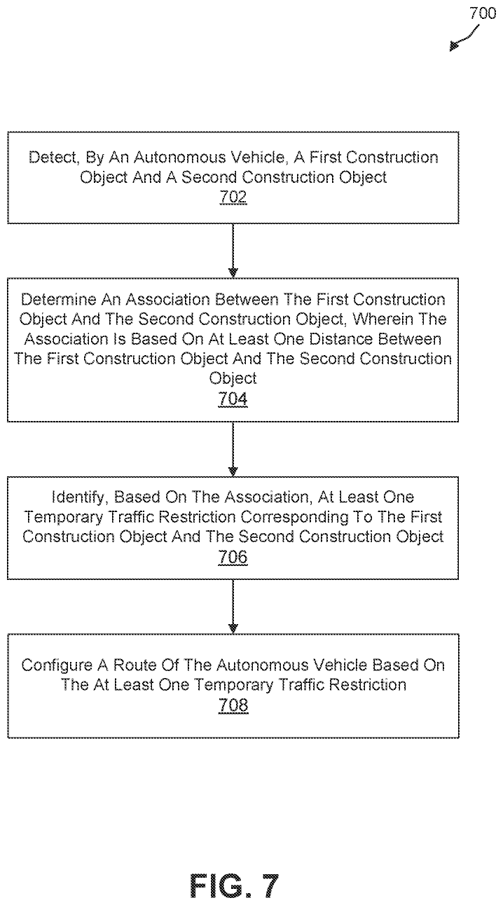

FIG. 7 illustrates a flowchart of an example process 700 for identifying a construction zone based on construction zone objects. At step 702, the process 700 includes detecting, by an autonomous vehicle, a first construction object and a second construction object. In some cases, the first construction object and the second construction object can include at least one of a cone, a post, a barrier, a barrel, a barricade, a sign, and a flare. For example, AV 302 can detect cone 304 and cone 306.

At step 704, the process 700 includes determining an association between the first construction object and the second construction object, wherein the association is based on at least one distance between the first construction object and the second construction object. In some examples, the at least one distance between the first construction object and the second construction object can include at least one of an absolute distance, a longitudinal distance, and a lateral distance. For instance, AV 302 can determine an association between cone 304 and cone 306 based on at least one of absolute distance 316, longitudinal distance 318, and/or lateral distance 320.

In some examples, the association can be based on a spatial relationship between the first construction object and the second construction object. In some aspects, the spatial relationship can be based on at least one of a distance of the first construction object or the second construction object relative to a first element in a traffic scene, an orientation of the first construction object or the second construction object, and a position of the first construction object or the second construction object relative to a second element in the traffic scene. For example, AV 302 can determine an association among one or more of cones 304-314 based on a spatial relationship among cones 304-314 and/or among at least one of cones 304-314 and an element in construction zone scene 300 (e.g., element such as a curb, lane boundary, vehicle, traffic signal, crosswalk, intersection, etc.)

In some cases, the association between the first construction object and the second construction object can be determined by a machine learning model configured to receive input from a perception stack of the autonomous vehicle. For example, construction object analysis module 208 can be implemented using a machine learning model (e.g., neural network 600) that is configured to receive input from perception stack 112 of AV 102.

At step 706, the process 700 includes identifying, based on the association, at least one temporary traffic restriction corresponding to the first construction object and the second construction object. In some cases, the at least one temporary traffic restriction includes at least one of a lane closure, a road closure, an emergency vehicle blockage, and a temporary traffic channelization. For instance, AV 302 can determine that there is a lane closure based on the association between two or more of cones 304-314.

At step 708, the process 700 includes configuring a route of the autonomous vehicle based on the at least one temporary traffic restriction. For example, AV 302 configure a route that merges onto the lane that is adjacent to the lane having the road closure in construction zone scene 300. In another example, AV 502 can determine revised route 510 based on the lane channelization as defined by cones 506 and cones 508.

In some aspects, the process 700 may include determining a first position of the first construction object and a second position of the second construction object, wherein the first position and the second position are relative to one or more points defined in a high-definition map, and wherein the association between the first construction object and the second construction object is further based on the first position and the second position. For example, AV 302 can determine a first position of cone 304 and a second position of cone 306 relative to a lane boundary or a curb that is defined by a high-definition map (e.g., semantic map database 202). In some cases, the one or more points in the high-definition map can correspond to at least one of an intersection, a crosswalk, a traffic lane boundary, a traffic lane, a traffic signal, and a traffic sign.

In some cases, the process 700 can include identifying an obstructed region on a thoroughfare, wherein the obstructed region is based on the association between the first construction object and the second construction object. For example, AV 402 can identify obstructed region 412 based on an association among cone 404, cone 406, and/or cone 408. In some examples, the process 700 may include determining a road blockage ratio that is based on a first size of the obstructed region and a second size of the thoroughfare. For instance, AV 402 can determine a road blockage ratio based on the width of obstructed region 412 (e.g., lateral distance 418) and the size of the thoroughfare (e.g., roadway width 410).

FIG. 8 illustrates an example processor-based system with which some aspects of the subject technology can be implemented. For example, processor-based system 800 can be any computing device making up local computing device 110, client computing device 170, a passenger device executing the ridesharing application 172, or any component thereof in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some examples, computing system 800 is a distributed system in which the functions described in this disclosure can be distributed within a datacenter, multiple data centers, a peer network, etc. In some cases, one or more of the described system components represents many such components each performing some or all of the function for which the component is described. In some cases, the components can be physical or virtual devices.

Example system 800 includes at least one processing unit (CPU or processor) 810 and connection 805 that couples various system components including system memory 815, such as read-only memory (ROM) 820 and random-access memory (RAM) 825 to processor 810. Computing system 800 can include a cache of high-speed memory 812 connected directly with, in close proximity to, and/or integrated as part of processor 810.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 can include an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L #), resistive random-access memory (RRAM/ReRAM), phase change memory (PCM), spin transfer torque RAM (STT-RAM), another memory chip or cartridge, and/or a combination thereof.

Storage device 830 can include software services, servers, services, etc., that when the code that defines such software is executed by the processor 810, causes the system to perform a function. In some examples, a hardware service that performs a particular function can include the software component stored in a computer-readable medium in connection with the necessary hardware components, such as processor 810, connection 805, output device 835, etc., to carry out the function.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the example aspects and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A method comprising: detecting a first construction object and a second construction object; determining an association between the first construction object and the second construction object, wherein the association is based on at least one distance between the first construction object and the second construction object; identifying, based on the association, at least one temporary traffic restriction corresponding to the first construction object and the second construction object; and configuring a route of an autonomous vehicle based on the at least one temporary traffic restriction.

Aspect 2. The method of Aspect 1, wherein the first construction object and the second construction object include at least one of a cone, a post, a barrier, a barrel, a barricade, a sign, and a flare.

Aspect 3. The method of any of Aspects 1 to 2, wherein the at least one distance between the first construction object and the second construction object includes at least one of an absolute distance, a longitudinal distance, and a lateral distance.

Aspect 4. The method of any of Aspects 1 to 3, further comprising: determining a first position of the first construction object and a second position of the second construction object, wherein the first position and the second position are relative to one or more points defined in a high-definition map, and wherein the association between the first construction object and the second construction object is further based on the first position and the second position.

Aspect 5. The method of Aspect 4, wherein one or more points in the high-definition map correspond to at least one of an intersection, a crosswalk, a traffic lane boundary, a traffic lane, a traffic signal, and a traffic sign.

Aspect 6. The method of any of Aspects 1 to 5, wherein the at least one temporary traffic restriction includes at least one of a lane closure, a road closure, an emergency vehicle blockage, and a temporary traffic channelization.

Aspect 7. The method of any of Aspects 1 to 6, further comprising: identifying an obstructed region on a thoroughfare, wherein the obstructed region is based on the association between the first construction object and the second construction object.

Aspect 8. The method of Aspect 7, further comprising: determine a road blockage ratio that is based on a first size of the obstructed region and a second size of the thoroughfare.

Aspect 9. The method of any of Aspects 1 to 8, wherein the association between the first construction object and the second construction object is determined by a machine learning model configured to receive input from a perception stack of the autonomous vehicle.

Aspect 10. An apparatus comprising: at least one memory; and at least one processor coupled to the at least one memory, wherein the at least one processor is configured to perform operations in accordance with any one of Aspects 1 to 9.

Aspect 11. An apparatus comprising means for performing operations in accordance with any one of Aspects 1 to 9.

Aspect 12. A non-transitory computer-readable medium comprising instructions that, when executed by an apparatus, cause the apparatus to perform operations in accordance with any one of Aspects 1 to 9.

Aspect 13. A method comprising: detecting a first construction object and a second construction object; determining an association between the first construction object and the second construction object, wherein the association is based on a spatial relationship between the first construction object and the second construction object; identifying, based on the association, at least one temporary traffic restriction corresponding to the first construction object and the second construction object; and configuring a route of an autonomous vehicle based on the at least one temporary traffic restriction.

Aspect 14. The method of Aspect 13, wherein the first construction object and the second construction object include at least one of a cone, a post, a barrier, a barrel, a barricade, a sign, and a flare.

Aspect 15. The method of any of Aspects 13 to 14, wherein the spatial relationship between the first construction object and the second construction object is based on at least one of a distance of the first construction object or the second construction object relative to a first element in a traffic scene, an orientation of the first construction object or the second construction object, and a position of the first construction object or the second construction object relative to a second element in the traffic scene.

Aspect 16. The method of any of Aspects 13 to 15, further comprising: determining a first position of the first construction object and a second position of the second construction object, wherein the first position and the second position are relative to one or more points defined in a high-definition map, and wherein the association between the first construction object and the second construction object is further based on the first position and the second position.

Aspect 17. The method of Aspect 16, wherein one or more points in the high-definition map correspond to at least one of an intersection, a crosswalk, a traffic lane boundary, a traffic lane, a traffic signal, and a traffic sign.

Aspect 18. The method of any of Aspects 13 to 17, wherein the at least one temporary traffic restriction includes at least one of a lane closure, a road closure, an emergency vehicle blockage, and a temporary traffic channelization.

Aspect 19. The method of any of Aspects 13 to 18, further comprising: identifying an obstructed region on a thoroughfare, wherein the obstructed region is based on the association between the first construction object and the second construction object.

Aspect 20. The method of Aspect 19, further comprising: determine a road blockage ratio that is based on a first size of the obstructed region and a second size of the thoroughfare.

Aspect 21. The method of any of Aspects 13 to 20, wherein the association between the first construction object and the second construction object is determined by a machine learning model configured to receive input from a perception stack of the autonomous vehicle.

Aspect 22. The method of any of Aspects 13 to 21, wherein the first construction object and the second construction object comprise a plurality of construction objects.

Aspect 23. An apparatus comprising: at least one memory; and at least one processor coupled to the at least one memory, wherein the at least one processor is configured to perform operations in accordance with any one of Aspects 13 to 22.

Aspect 24 An apparatus comprising means for performing operations in accordance with any one of Aspects 13 to 22.

Aspect 25. A non-transitory computer-readable medium comprising instructions that, when executed by an apparatus, cause the apparatus to perform operations in accordance with any one of Aspects 13 to 22.

What is claimed is:

1. An autonomous vehicle comprising:
a memory; and
one or more processors coupled to the memory, the one or more processors being configured to:
detect a first construction object and a second construction object;
determine an association between the first construction object and the second construction object, wherein the association is based on at least one distance between the first construction object and the second construction object;
identify, based on the association, at least one temporary traffic restriction corresponding to the first construction object and the second construction object; and
configure a route of the autonomous vehicle based on the at least one temporary traffic restriction.

2. The autonomous vehicle of claim 1, wherein the first construction object and the second construction object include at least one of a cone, a post, a barrier, a barrel, a barricade, a sign, and a flare.

3. The autonomous vehicle of claim 1, wherein the at least one distance between the first construction object and the second construction object includes at least one of an absolute distance, a longitudinal distance, and a lateral distance.

4. The autonomous vehicle of claim 1, wherein the one or more processors are further configured to:
determine a first position of the first construction object and a second position of the second construction object, wherein the first position and the second position are relative to one or more points defined in a high-definition map, and wherein the association between the first construction object and the second construction object is further based on the first position and the second position.

5. The autonomous vehicle of claim 4, wherein one or more points in the high-definition map correspond to at least one of an intersection, a crosswalk, a traffic lane boundary, a traffic lane, a traffic signal, and a traffic sign.

6. The autonomous vehicle of claim 1, wherein the at least one temporary traffic restriction includes at least one of a lane closure, a road closure, and a temporary traffic channelization.

7. The autonomous vehicle of claim 1, wherein the one or more processors are further configured to:
identify an obstructed region on a thoroughfare, wherein the obstructed region is based on the association between the first construction object and the second construction object.

8. The autonomous vehicle of claim 7, wherein the one or more processors are further configured to:
determine a road blockage ratio that is based on a first size of the obstructed region and a second size of the thoroughfare.

9. The autonomous vehicle of claim 1, wherein the association between the first construction object and the second construction object is determined by a machine learning model configured to receive input from a perception stack of the autonomous vehicle.

10. A method comprising:
detecting, by an autonomous vehicle, a first construction object and a second construction object;
determining an association between the first construction object and the second construction object, wherein the association is based on a spatial relationship between the first construction object and the second construction object;
identifying, based on the association, at least one temporary traffic restriction corresponding to the first construction object and the second construction object; and
configuring a route of the autonomous vehicle based on the at least one temporary traffic restriction.

11. The method of claim 10, wherein the spatial relationship between the first construction object and the second construction object is based on at least one of a distance of the first construction object or the second construction object relative to a first element in a traffic scene, an orientation of the first construction object or the second construction object, and a position of the first construction object or the second construction object relative to a second element in the traffic scene.

12. The method of claim 10, further comprising:
determining a first position of the first construction object and a second position of the second construction object, wherein the first position and the second position are relative to one or more points defined in a high-definition map, and wherein the association between the first construction object and the second construction object is further based on the first position and the second position.

13. The method of claim 12, wherein one or more points in the high-definition map correspond to at least one of an intersection, a crosswalk, a traffic lane boundary, a traffic lane, a traffic signal, and a traffic sign.

14. The method of claim 10, wherein the at least one temporary traffic restriction includes at least one of a lane closure, a road closure, and a temporary traffic channelization.

15. The method of claim 10, further comprising:
identifying an obstructed region on a thoroughfare, wherein the obstructed region is based on the association between the first construction object and the second construction object.

16. The method of claim 15, further comprising:
determining a road blockage ratio that is based on a first size of the obstructed region and a second size of the thoroughfare.

17. The method of claim 10, wherein the first construction object and the second construction object comprise a plurality of construction objects.

18. A non-transitory computer-readable media comprising instructions stored thereon which, when executed are configured to cause a computer or processor to:
detect a first construction object and a second construction object;
determine an association between the first construction object and the second construction object, wherein the association is based on at least one distance between the first construction object and the second construction object;
identify, based on the association, at least one temporary traffic restriction corresponding to the first construction object and the second construction object; and
configure a route of an autonomous vehicle based on the at least one temporary traffic restriction.

19. The non-transitory computer-readable media of claim 18, comprising further instructions configured to cause the computer or the processor to:
determine a first position of the first construction object and a second position of the second construction object, wherein the first position and the second position are relative to one or more points defined in a high-definition map, and wherein the association between the first construction object and the second construction object is further based on the first position and the second position.

20. The non-transitory computer-readable media of claim 18, comprising further instructions configured to cause the computer or the processor to:
identify an obstructed region on a thoroughfare, wherein the obstructed region is based on the association between the first construction object and the second construction object.
